(19) United States
(12) Patent Application Publication
(10) Pub. No.: US 2008/0122719 A1
(43) Pub. Date: May 29, 2008

(54) Antenna device

(75) Inventor: Yu Ching Tsen, Tauyuan Hsien (TW)

Correspondence Address: CHARLES E. BAXLEY, ESQ., 90 JOHN STREET, THIRD FLOOR, NEW YORK, NY, 10038, US

(73) Assignee: Joymax Electronics Co., Ltd.

(21) Appl. No.: 11/505,159

(22) Filed: Aug. 15, 2006

(51) Int. Cl. H01Q 1/50; H01Q 1/52; H01Q 1/36

(52) U.S. Cl. 343/841; 343/906; 343/895

(57) ABSTRACT

An antenna device includes a coupling tube, a conductor member received in the coupling tube and having one end for electrically coupling to an electric facility, a socket member electrically coupled to the other end of the conductor member and having a socket opening for coupling to an antenna member. An insert may be disposed in the coupling tube and engaged between the coupling tube and the conductor member. A housing includes a chamber for receiving the socket member. The antenna member includes an antenna core having two or more electric rods wound together to form a helical structure having a decreased length.

### BACKGROUND OF THE INVENTION

1. Field of the Invention

The present invention relates to an antenna device, and more particularly to an antenna device including a simplified and reduced structure for detachably attaching or coupling to small electric facilities, such as network card devices or the like.

2. Description of the Prior Art

Typical antenna devices have been developed and provided for attaching to electric or telecommunicating facilities for communicating with similar electric or telecommunicating equipments located at far distances away. For example, in various telecommunicating systems, various kinds of antenna devices have been developed and provided for communicating between ground stations on earth and/or satellites.

U.S. Pat. No. 7,038,636 to Larouche et al. discloses one of the typical helical antenna devices comprising a helix supported by a helix support which includes a flexible sheet having its two surfaces covered with a layer of antistatic materials, and a grounding mechanism electrically grounds the external sheet surface to the helix and the two sheet surfaces to one another, such that the combination of the helix and the flexible support renders the typical helical antenna devices structurally relatively rigid in all directions.

However, the typical helical antenna devices comprise a relatively complicated and large structure that may be used for attaching to large electric or telecommunicating facilities or equipments only, but may not be used for attaching to small electric or telecommunicating facilities or equipments, such as the network card devices for telecommunicating purposes.

The present invention has arisen to mitigate and/or obviate the afore-described disadvantages of the conventional antenna devices for telecommunicating systems or facilities or equipments.

### SUMMARY OF THE INVENTION

The primary objective of the present invention is to provide an antenna device including a simplified and reduced structure for detachably attaching or coupling to small electric facilities, such as network card devices or the like.

In accordance with one aspect of the invention, there is provided an antenna device comprising a coupling tube, a conductor member received in the coupling tube and including a first end for electrically coupling to an electric facility, and including a second end, a socket member electrically coupled to the second end of the conductor member, and including a socket opening formed therein, and an antenna member including a first end engaged with the socket opening of the socket member for electrically coupling to the socket member and the conductor member and for forming a simplified antenna device.

The second end of the conductor member may be selected from a coupler for electrically coupling the second end of the conductor member to the socket member.

The coupling tube includes an insert disposed therein and engaged between the coupling tube and the conductor member for supporting the conductor member within the coupling tube. The insert includes a space formed in an outer portion thereof, and the first end of the conductor member is located within the space of the insert of the coupling tube.

A housing may further be provided and may include a chamber formed therein, the socket member is disposed in the chamber of the housing and electrically coupled to the second end of the conductor member. The housing includes an outlet port formed therein and communicating with the socket opening of the socket member for receiving the first end of the antenna member.

The antenna member includes an antenna core having at least two or more electric rods. The electric rods of the antenna core of the antenna member are wound together to form a helical structure which includes a relatively reduced or decreased length and/or volume for allowing the antenna device to be detachably attached or coupled to various small electric facilities. A shield may further be provided and engaged onto the antenna core of the antenna member for shielding and protecting the antenna core.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial perspective view illustrating an attachment of an antenna device in accordance with the present invention to a small electric facility, such as the network card device, and illustrating the operation of the antenna device;

FIG. 2 is a perspective view of the antenna device;

FIG. 3 is a perspective view similar to FIG. 2, in which an outer shield of the antenna device has been removed for showing an inner structure of the antenna device; and

FIG. 4 is a cross sectional view of the antenna device taken along lines 4-4 of FIG. 2.

### DETAILED DESCRIPTION OF THE PREFERRED EMBODIMENT

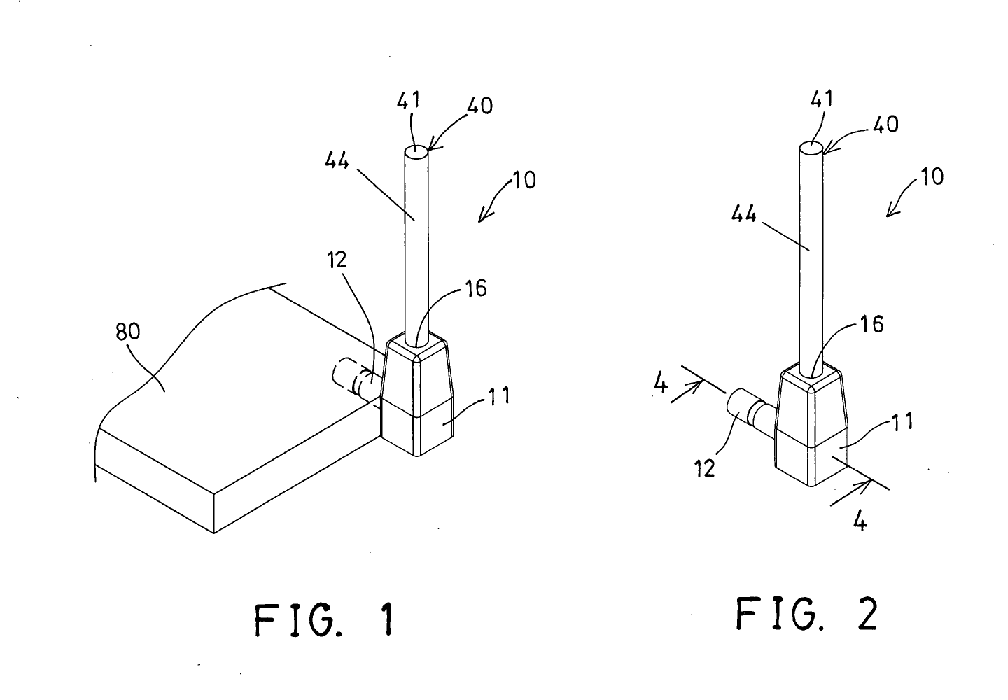

Referring to the drawings, and initially to FIGS. 1-3, an antenna device 10 in accordance with the present invention is designed and arranged for detachably attaching or coupling to small electric facilities 80, such as a network card device 80 as shown in FIG. 1 or the like, and for telecommunicating purposes. The antenna device 10 comprises a housing 11 including a coupling tube 12 extended outwardly therefrom for receiving a conductor member 20 therein (FIG. 4) which is provided for signal receiving or transmitting or telecommunicating purposes. It is preferable that an electrically insulating spacer or insert 13 is also disposed in the coupling tube 12 and disposed or engaged between the coupling tube 12 and the conductor member 20 for suitably supporting the conductor member 20 within the coupling tube 12.

The coupling tube 12 and/or the insert 13 includes a space 14 formed in the outer portion thereof, and the conductor member 20 includes an outer free or first end 21 extended or located within the space 14 of the coupling tube 12 or the insert 13 for electrically coupling to the electric facilities 80, and includes an inner end 22 located within an inner chamber 15 of the housing 11. A socket member 30 is disposed or engaged in the chamber 15 of the housing 11 and electrically contacted or engaged with or coupled to the inner end 22 of the conductor member 20, and includes a socket opening 31 formed therein and aligned with or communicating with an outlet port 16 of the housing 11 for receiving or engaging with an antenna member 40. The inner end 22 of the conductor member 20 may be selected a coupler or the like for electrically coupling to the socket member 30.

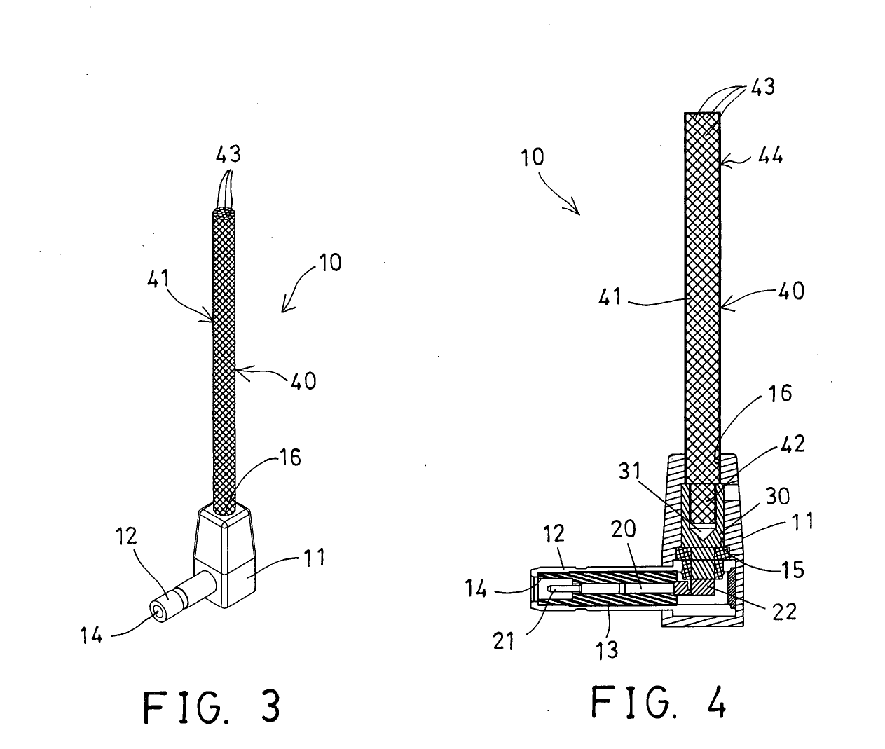

The antenna member 40 includes an antenna body or core 41 having a free end or lower or first end 42 engaged into or through the outlet port 16 of the housing 11 and engaged with the socket opening 31 of the socket member 30 with such as a force-fitted engagement for electrically coupling to the socket member 30 and the conductor member 20 and for signal receiving or transmitting or telecommunicating purposes. The antenna core 41 of the antenna member 40 may include two or more electric wires or cables or rods 43 (FIGS. 3, 4) wound or entangled together to form such as a helical structure, and the antenna member 40 may include an outer cover or shield 44 engaged onto or around the antenna core 41 of the antenna member 40 for shielding and protecting the antenna core 41.

It is to be noted that, as shown in FIG. 4, the socket member 30 is simply disposed or engaged in the chamber 15 of the housing 11 and electrically contacted or engaged with or coupled to the inner end 22 of the conductor member 20 without being welded or solidly secured or coupled to the inner end 22 of the conductor member 20 such that the manufacturing or the assembling operation of the antenna device 10 may be simplified. In addition, the antenna device 10 in accordance with the present invention includes a simplified and reduced structure having relatively fewer elements or parts for allowing the manufacturing cost to be reduced or decreased, and also for allowing the antenna device 10 to be detachably attached or coupled to various small electric facilities 80, such as the network card devices 80 or the like.

It is further to be noted that the electric wires or cables or rods 43 of the antenna core 41 of the antenna member 40 that are wound or entangled together to form such as a helical structure may include a relatively reduced or decreased length and/or volume, and thus for allowing the antenna device 10 to be detachably attached or coupled to various small electric facilities 80.

Accordingly, the antenna device in accordance with the present invention includes a simplified and reduced structure for detachably attaching or coupling to small electric facilities, such as network card devices or the like.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An antenna device comprising:
a coupling tube,
a conductor member received in said coupling tube and including a first end for electrically coupling to an electric facility, and including a second end,
a socket member electrically coupled to said second end of said conductor member, and including a socket opening formed therein, and
an antenna member including a first end engaged with said socket opening of said socket member for electrically coupling to said socket member and said conductor member.

2. The antenna device as claimed in claim 1, wherein said second end of said conductor member is a coupler for electrically coupling to said socket member.

3. The antenna device as claimed in claim 1, wherein said coupling tube includes an insert disposed therein and engaged between said coupling tube and said conductor member for supporting said conductor member within said coupling tube.

4. The antenna device as claimed in claim 3, wherein said insert includes a space formed in an outer portion thereof, and said first end of said conductor member is located within said space of said insert of said coupling tube.

5. The antenna device as claimed in claim 1 further comprising a housing having a chamber formed therein, said socket member being disposed in said chamber of said housing and electrically coupled to said second end of said conductor member.

6. The antenna device as claimed in claim 5, wherein said housing includes an outlet port formed therein and communicating with said socket opening of said socket member for receiving said first end of said antenna member.

7. The antenna device as claimed in claim 1, wherein said antenna member includes an antenna core having at least two or more electric rods.

8. The antenna device as claimed in claim 7,.wherein said electric rods of said antenna core of said antenna member are wound together to form a helical structure.

9. The antenna device as claimed in claim 1, wherein said antenna member includes an antenna core, and a shield engaged onto said antenna core of said antenna member for shielding and protecting said antenna core.
